(19) United States
(12) Patent Application Publication
(10) Pub. No.: US 2006/0105298 A1
(43) Pub. Date: May 18, 2006

(54) Decorative device for human teeth

(76) Inventors: German Andres Escudero, Buenos Aires (AR); Javier Encabo, Buenos Aires (AR)

Correspondence Address: WENDEROTH, LIND & PONACK, L.L.P., 2033 K STREET N. W., SUITE 800, WASHINGTON, DC, 20006-1021, US

(21) Appl. No.: 11/274,251

(22) Filed: Nov. 16, 2005

(30) Foreign Application Priority Data
Nov. 17, 2004 (AR) M 20040104243

(51) Int. Cl. A61C 5/00

(52) U.S. Cl. 433/215

(57) ABSTRACT

A decorative device for human teeth consists in fixing on a vestibule surface of a tooth or vestibule surfaces of a group of teeth, some decorative element in the form of a plate, polished or colored, made of metal or plastic, thereby producing a remarkable attraction on a user's teeth. The decorative device can be applied in a permanent mode, by adhering the decorative element to a vestibule surface of the tooth, or in a removable mode by pressing specially designed frames to hold in place a decoration fixed to the vestibule surface. Microspheres arranged in frame free surfaces, can be added to a metallic structure of chromium or a similar metal.

### FIELD OF THE INVENTION

The instant invention pertains to a decorative device for human teeth that aims at a constructive singular disposition to achieve a number of original, practical, as well as technical and economical advantages.

### BACKGROUND OF THE INVENTION

This present decorative conception for human teeth is of practical as well as aesthetic usefulness. It is true that different forms of decoration have been taking place with regard to skin of humans, like precious stone implants, tattooing, and piercing of an ear lobe, nose, neck, eyebrows, lips or navel for receipt of ornaments. However, never before has decorating teeth or an entire denture of a human being by virtue of adding or fixing some kind of ornamental device to beautify, or at least to call attention of our fellow men on that particular point, been done.

### SUMMARY OF THE INVENTION

As a general matter, the present invention consists in fixing of one decorative element on a vestibule surface of one particular tooth, or it may cover a group of several different teeth. The decorative element is a polished or colored plate of metal or plastic, of a very outstanding format, design or color, thereby creating a singularly attractive effect on teeth of a user without any unwanted secondary effect and without being applied in an iatrogenic manner, because binding takes place by adhering the decorative element to the vestibule surface of the tooth or group of teeth, or by pressing a specially designed frame to hold the decorating plate on that surface of the tooth or group of teeth without interfering with mechanics of mastication, and without altering dental hygiene or a dental condition as a whole. On the other hand, in certain cases it will be useful to decorate, and thereby enhance a certain therapeutic or corrective appliance that a user may be forced to wear. Thus, micro-spheres can be added to a chrome metal structure or similar structure so as to provide fanciful shapes on a chrome surface that is free of support in a mouth.

### BRIEF DESCRIPTION OF THE DRAWINGS

For the present invention to be clearly comprehended and easily adopted, it is presented in the illustrative drawings in which:

FIG. 1 is a perspective view of a removable ornamental device as an example object of the present invention simulating a shape of a lightning bolt, made of a metal plate (cobalt chrome or a similar metal), that covers vestibule surfaces of various adjoining teeth; the ornamental device is kept in place with inside retention against a lingual palatal surface of one tooth of a user.

FIG. 2 is a view of one decorative device presenting a shape of a dragon colored in green, that can be fixed or removable, depending on whether the decorative device is adhered to vestibule surfaces of teeth, or kept in place by use of interdental bridles at palatal surfaces of other teeth.

FIG. 3 is a ground plan view of an inside of a plaster model that reproduces a palate of an assumed user, demonstrating inside bridles of retention of one ornament against lingual palatal surfaces of two teeth that are going to hold a removable ornament like one shown in FIG. 4.

FIG. 4 is an elevational view of a plaster model showing how an ornament of polished metal of the present invention is going to look once finished and ready to be placed in a removable way, with the ornament including a fanciful shape including a combination of curves and planes.

FIG. 5 is a perspective view, before being placed “in situ”, of a removable ornament, showing its entire metal structure.

FIG. 6 is a view of the ornament illustrated in FIG. 5, placed on a user's teeth.

FIG. 7 is a view of one ornament made of a metal plate, polished or enameled, or of acrylic, that can be fixed or removable.

FIG. 8 is a view of the ornament like the one illustrated in FIG. 1, which is removable and of a scimitar shape.

FIG. 9(a) is a ground plan view showing supporting metal structure and links of ornaments demonstrating micro-spheres in a palatal arch of the structure, which is removable.

FIG. 9(b) is a front elevational view of a plurality of teeth with a diversity of fixed, not linked, ornamental devices.

FIG. 10 is an elevational view showing a combined ornamental plate with a fanciful shape of colored flowers and leaves that can be made of acrylic or combined metals, and which can be fixed or removable.

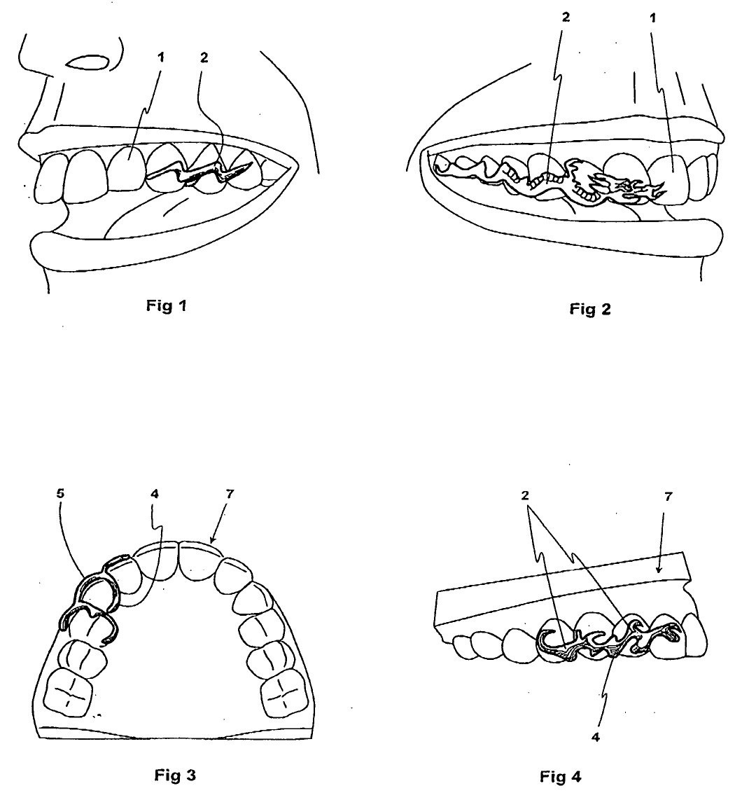

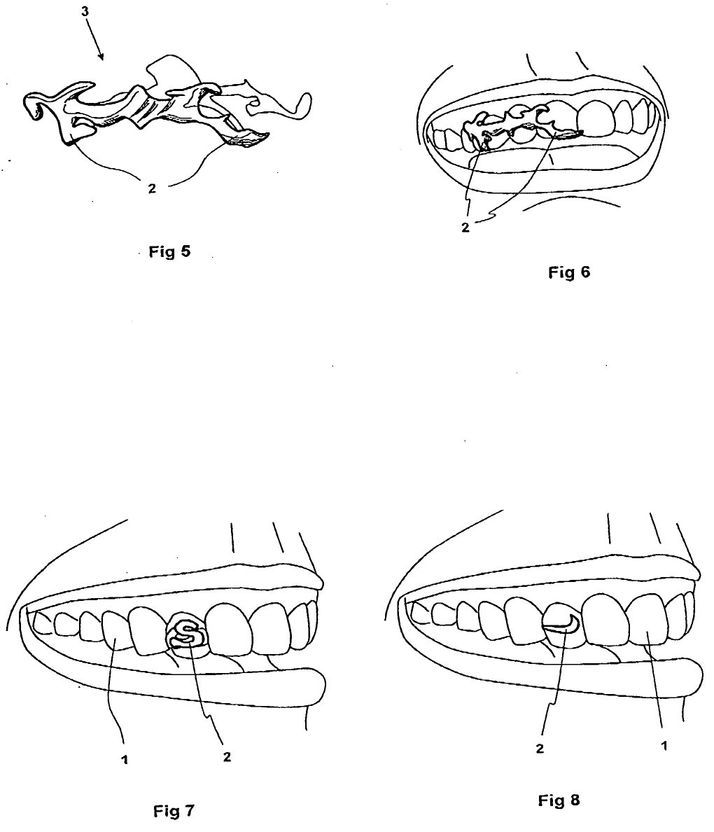

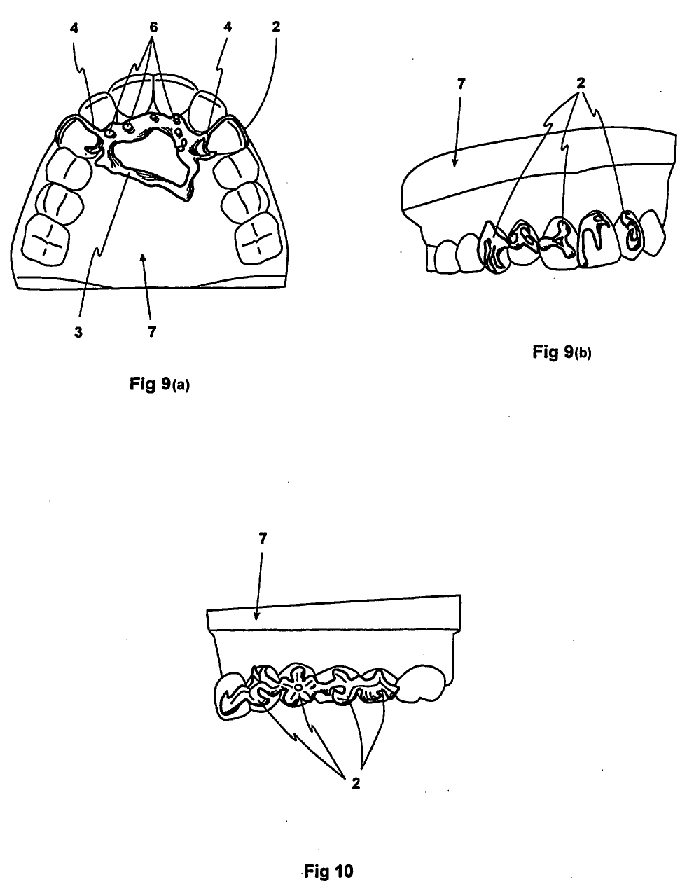

### DETAILED DESCRIPTION OF THE PREFERRED EMBODIMENTS

In the figures, the same reference numbers indicate equal parts or equivalents.

In the drawings number 1 indicates human teeth on which an ornamental object of this invention has been applied; number 2 indicates removable ornamental or decorative plates including ones made of polished colored metals or acrylic; number 3 indicates fixing frames or holding structure that links interdental bridles meant to keep in place the removable decorative plates that in this particular case are made of cobalt chrome or another metal of similar characteristics; number 4 indicates the interdental bridles that fix the decorative plates; number 6 indicates sensory micro-spheres; and number 7 indicates a plaster model in which structures and ornaments were set.

In reference to production and fixing of the ornamental or decorative plate(s) (2) to a user's teeth (1), according to this invention, there are two ways of performing such production, as follows.

In accordance with a first of these ways the ornamental or decorative plate (2) is positioned in such a way that it is fixed to a vestibule surface or surfaces of the user's teeth (1), wherein the user has different choices of forms or colors as well as material from which the decorative plates (2) will be produced, which material could be metallic or plastic. In both cases, a best quality of dentistry material will be used in order to guarantee best results; that is gold, cobalt chromium, titanium, acrylic, and the like will be used. This way includes a previous realization of micro retentions, provided by performing a sandblasting operation, in a surface of the vestibule surface(s) of the teeth (1) to which the decorative plate(s) (2) will be applied, and once this job is complete the plate(s) are cemented to the teeth with a dental composite (amalgam).

In accordance with a second way, the ornamental or decorative plates are removably attached. In this case of removable ornaments, even though it seems more complicated to execute, sometimes it's the user's choice to combine a possibility of a repairing therapy, like for instance fixing of a dental prosthesis going beyond mere aesthetics without missing this objective, in which case it will be necessary to make a study of the user's dental condition by taking an imprint of the teeth with a rigid tray and a negative copy of the teeth on silicone or any other similar elastomeric material, or else with sodium alginate (hydro colloidal). All of these materials allow an exact copy of the original teeth, taking care that they are clean from saliva or blood stains from the patient's mouth. This result should be a very good copy of the teeth in a model (7), which work can be finished with stone plaster (densita-type: III; IV or V). A model to work in is shaped, including an antagonistic model and a maxillary internal registry; i.e. an entire model generally mounted on articulation (not shown in the drawings) that allows reproduction of the exact toothmarks of the patient and positioning of the teeth (1). Additionally, if there is any tooth missing, this will allow to be checked a relationship of a maxillary function and occlusive dynamics, showing exact dimensions, by which can be set up the frames (3), the interdental bridles or connecting bindings (4) of the decorative plates (2) on the vestibule surface of the teeth (1), anchored in existing teeth and without interfering with the articulation or bite, and with no risks to health or hygiene of the user's mouth.

The ornamental or decorative plates (1) can be made of dentistry metal (gold, chromium, cobalt, titanium, and the like) polished like a mirror, acting correctly inside the mouth, without producing any unwanted ionic discharges in that area, as a result being totally inalterable, and the same is true with regard to the acrylic materials. In both cases the fixing elements and the ornaments could be removed without any damage or harm being produced in any way to the teeth, in the same way that orthodontic braces are removed.

Other advantages of this invention are a possibility that the ornamental or decorative plate (2) could be made according to forms or designs provided by the user, as shown in the drawings, displaying to cover one tooth or a group of teeth (1), allowing a variety of combinations of metal and acrylic; a choice of colors; or a setting of stones, e.g. diamonds, in relief or flat plated. Additionally, any aesthetic shaping including sensory micro spheres (6) can be utilized. Or, in case of any therapeutic material (prosthesis), fixing of the prosthesis takes place in the frames (3) and the interdental bridles (4) such that visible fixing endings will appear on the user's own teeth like an aesthetic ornamental plate (2), thereby being exhibited in the vestibule surfaces of the teeth (1).

1-5. (canceled)

6. A decorative device for human teeth, comprising:
an ornamental plate;
a frame; and
a bridle interconnecting said ornamental plate and said frame,
wherein said ornamental plate is to be fixed to a vestibule surface of a tooth by pressing said frame against a palatal surface such that said bridle holds said ornamental plate in place on the vestibule surface of the tooth.

7. The decorative device according to claim 6, wherein
said ornamental plate comprises a metal or plastic ornamental plate that is polished or colored.

8. The decorative device according to claim 7, wherein
said frame comprises a metallic frame.

9. The decorative device according to claim 8, wherein
said ornamental plate is to be removably fixed to the vestibule surface of the tooth.

10. The decorative device according to claim 9, wherein
said bridle comprises an arch that is to be positioned along a palatal lingual surface of the tooth.

11. The decorative device according to claim 10, wherein
said metallic frame has micro spheres in a free surface of said metallic frame.

12. The decorative device according to claim 8, further comprising:
a dentistry adhesive to be applied over the vestibule surface of the tooth so as to cement said ornamental plate to the vestibule surface of the tooth upon pressing said metallic frame against the palatal surface.

13. The decorative device according to claim 12, wherein
said bridle comprises an arch that is to be positioned along a palatal lingual surface of the tooth.

14. The decorative device according to claim 13, wherein
said metallic frame has micro spheres in a free surface of said metallic frame.

15. A method for decorating human teeth, comprising:
providing a decorative device including an ornamental plate, a frame, and a bridle interconnecting said ornamental plate and said frame;
fixing said ornamental plate to a vestibule surface of a tooth by pressing said metallic frame against a palatal surface such that said bridle holds said ornamental plate in place on the vestibule surface of the tooth.

16. The method according to claim 15, wherein
said ornamental plate comprises a metal or plastic ornamental plate that is polished or colored.

17. The method according to claim 16, wherein
said frame comprises a metallic frame.

18. The decorative device according to claim 17, wherein
fixing said ornamental plate to a vestibule surface of a tooth comprises removably fixing said ornamental plate said vestibule surface of said tooth.

19. The decorative device according to claim 18, wherein
said bridle comprises an arch such that removably fixing said ornamental plate to said vestibule surface of said tooth includes positioning said arch along a palatal lingual surface of said tooth.

20. The decorative device according to claim 19, wherein
said metallic frame has micro spheres in a free surface of said metallic frame.

21. The method according to claim 17, further comprising:
prior to pressing said metallic frame against said palatal surface, applying a dentistry adhesive over said vestibule surface of said tooth such that fixing said ornamental plate to a vestibule surface of a tooth comprises cementing said ornamental plate to said vestibule surface of said tooth.

22. The method according to claim 21, further comprising:
prior to applying a dentistry adhesive over said vestibule surface of said tooth, sandblasting said vestibule surface of said tooth.

23. The decorative device according to claim 22, wherein
said bridle comprises an arch such that cementing said ornamental plate to said vestibule surface of said tooth includes positioning said arch along a palatal lingual surface of said tooth.

24. The decorative device according to claim 23, wherein
said metallic frame has micro spheres in a free surface of said metallic frame.
